(19) United States
(12) Patent Application Publication
(10) Pub. No.: US 2026/0171021 A1
(43) Pub. Date: Jun. 18, 2026

(54) LIGHT EMITTING DISPLAY APPARATUS

(71) Applicants: LG Display Co., Ltd., Seoul (KR); SNU R&DB FOUNDATION, Seoul (KR)

(72) Inventors: KeyYoung YANG, Paju-si (KR); Soo-Yeon LEE, Seoul (KR); SangHee YU, Paju-si (KR); MoonSeok JUNG, Paju-si (KR)

(73) Assignees: LG Display Co., Ltd., Seoul (KR); SNU R&DB FOUNDATION, Seoul (KR)

(21) Appl. No.: 19/374,871

(22) Filed: Oct. 30, 2025

(30) Foreign Application Priority Data
Dec. 18, 2024 (KR) 10-2024-0189440

(51) Int. Cl. G09G 3/3233

(52) U.S. Cl. CPC G09G 3/3233; G09G 2300/043; G09G 2300/0819

(57) ABSTRACT

A light emitting display apparatus includes a light emitting device configured to emit light; and a pixel driving circuit configured to drive the light emitting device. The pixel driving circuit includes: a first circuit part including a driving transistor and connected to a data line and a first driving voltage line to which a first driving voltage is supplied; a second circuit part connected to the light emitting device and to a second driving voltage line to which a second driving voltage is supplied; and an emission transistor connected between the first circuit part and the second circuit part.

### CROSS-REFERENCE TO RELATED APPLICATIONS

This application claims the benefit of and priority to Korean Patent Application No. 10-2024-0189440 filed on Dec. 18, 2024, the entire contents of which are incorporated herein by reference for all purposes.

### BACKGROUND

### 1. Technical Field

The present disclosure relates to a light emitting display apparatus.

### 2. Description of Related Art

Light emitting display apparatuses are mounted on or provided in electronic products such as televisions, monitors, notebook computers, smart phones, tablet computers, electronic pads, wearable devices, watch phones, portable information devices, navigation devices, or vehicle control display devices, etc., to display images.

A light emitting display panel constituting a light emitting display apparatus is provided with pixels, and each of the pixels is provided with a light emitting device.

When a light emitting display apparatus is used for a long period of time, a driving transistor may undergo degradation, and accordingly, light may not be normally emitted from a light emitting device connected to the driving transistor. Therefore, there may arise a problem in that the quality of the light emitting display apparatus deteriorates.

The description of related art should not be considered prior art merely because it is mentioned in or associated with this section. The description of related art includes information that describes one or more aspects of the subject technology, and the description in this section does not limit the scope of the present disclosure.

### SUMMARY

One or more aspects of the present disclosure are directed to providing a light emitting display apparatus that substantially obviates one or more problems due to limitations and disadvantages of the related art.

An aspect of the present disclosure is directed to providing a light emitting display apparatus capable of emitting light from a light emitting device regardless of a threshold voltage of a driving transistor.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other advantages and in accordance with the purpose of the disclosure, as embodied and broadly described herein, in one or more aspects, there is provided a light emitting display apparatus comprising a light emitting device configured to emit light; and a pixel driving circuit configured to drive the light emitting device, wherein the pixel driving circuit comprises: a first circuit part including a driving transistor and connected to a data line and a first driving voltage line to which a first driving voltage is supplied; a second circuit part connected to the light emitting device and to a second driving voltage line to which a second driving voltage is supplied; and an emission transistor connected between the first circuit part and the second circuit part.

It is to be understood that both the foregoing general description and the following detailed description of the present disclosure are examples and explanatory and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is an example diagram illustrating a configuration of a light emitting display apparatus according to an embodiment of the present disclosure;

FIG. 2 is an example diagram illustrating a structure of a pixel applied to a light emitting display apparatus according to an embodiment of the present disclosure;

FIG. 3 is an example diagram illustrating a structure of a control driver applied to a light emitting display apparatus according to an embodiment of the present disclosure;

FIG. 4 is an example diagram illustrating a structure of a gate driver applied to a light emitting display apparatus according to an embodiment of the present disclosure;

FIG. 5 is an example diagram illustrating a structure of a data driver applied to a light emitting display apparatus according to an embodiment of the present disclosure;

FIG. 6 is an example diagram illustrating waveforms of signals supplied to a pixel applied to a light emitting display apparatus according to an embodiment of the present disclosure;

FIG. 7 is an example diagram illustrating a structure during an initialization period of a pixel applied to a light emitting display apparatus according to an embodiment of the present disclosure;

FIG. 8 is an example diagram illustrating a structure during a threshold voltage sensing period of a pixel applied to a light emitting display apparatus according to an embodiment of the present disclosure;

FIG. 9 is an example diagram illustrating a structure during a data writing period of a pixel applied to a light emitting display apparatus according to an embodiment of the present disclosure;

FIG. 10 is an example diagram illustrating a structure during a reset period of a pixel applied to a light emitting display apparatus according to an embodiment of the present disclosure;

FIG. 11 is an example diagram illustrating a structure during a light emission period of a pixel applied to a light emitting display apparatus according to an embodiment of the present disclosure;

FIGS. 12 to 14 are other example diagrams illustrating a structure of a pixel applied to a light emitting display apparatus according to an embodiment of the present disclosure;

FIG. 15 is an example diagram illustrating waveforms of signals supplied to the pixel illustrated in FIGS. 13 and 14; and

FIGS. 16A to 16D are example diagrams illustrating the effect depending on a change in the magnitude of the second driving voltage applied to a display apparatus according to an embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Reference will now be made in detail to the example embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate (ly),” or “direct(ly)” is used.

It will be understood that, although the terms “first,” “second,” etc. can be used herein to describe various elements, these elements should not be limited by these terms. These terms are merely used to refer to one element separately from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. The expression that an element is “connected,” “coupled,” or “adhered” to another element or layer should be understood the element or layer cannot only be directly connected or adhered to another element or layer, but also be indirectly connected or adhered to another element or layer with one or more intervening elements or layers “disposed,” or “interposed” between the element or layer and the another element or layer, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may”.

The term “part” or “unit” may refer to or include, for example, a circuit, a component, a device, an integrated circuit, a computational block of a circuit device, or a structure configured to perform a described function.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings.

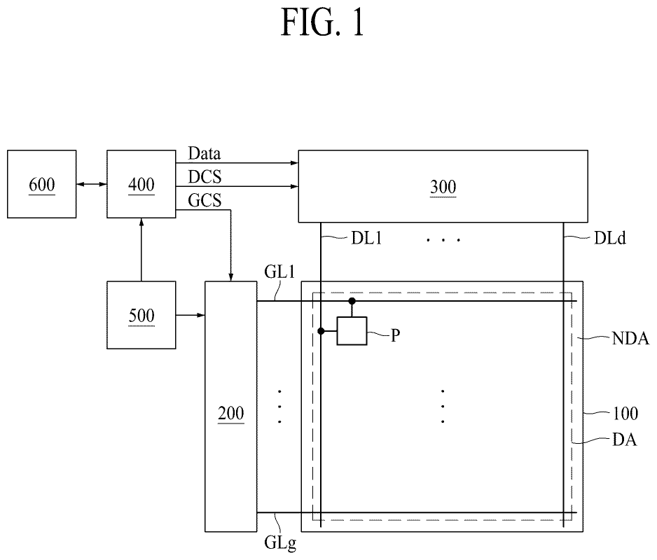

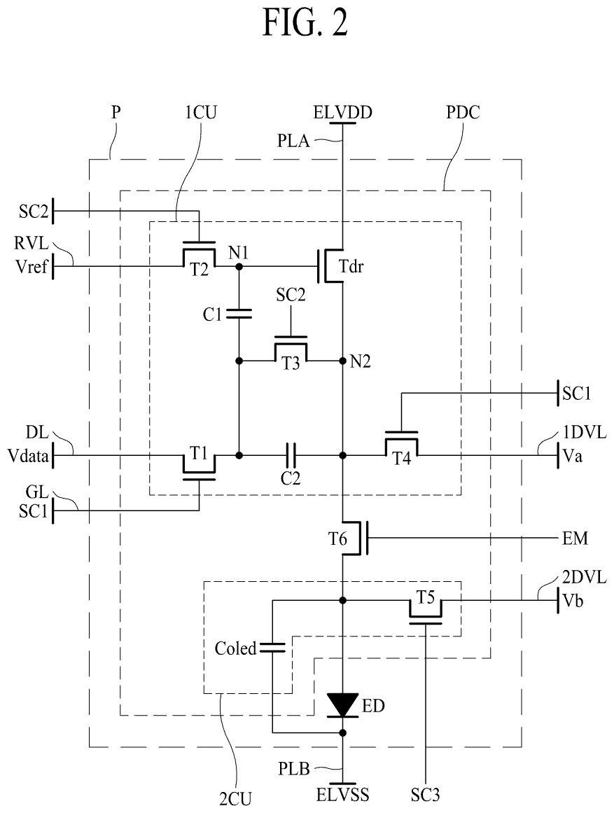

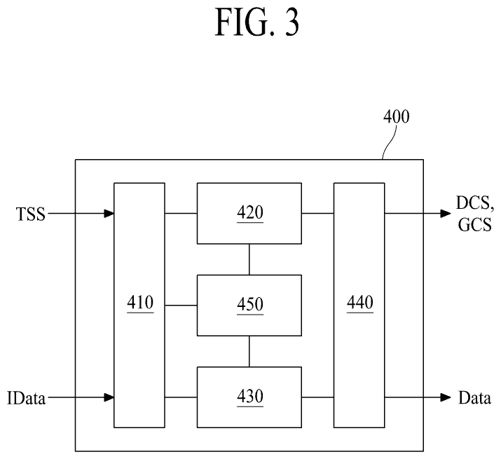

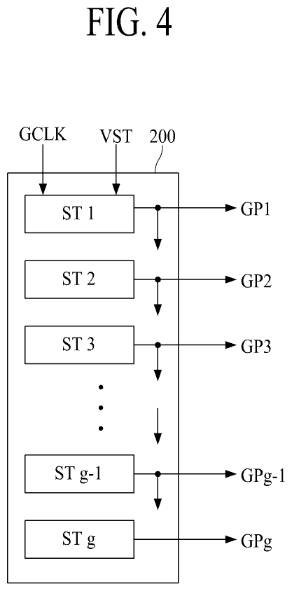

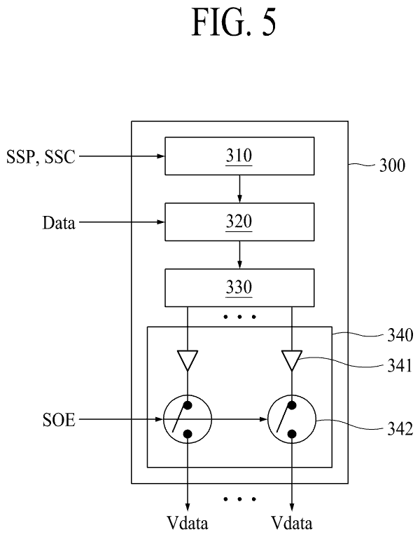

FIG. 1 is an example diagram illustrating a configuration of a light emitting display apparatus according to an embodiment of the present disclosure, FIG. 2 is an example diagram illustrating a structure of a pixel applied to a light emitting display apparatus according to an embodiment of the present disclosure, FIG. 3 is an example diagram illustrating a structure of a control driver applied to a light emitting display apparatus according to an embodiment of the present disclosure, FIG. 4 is an example diagram illustrating a structure of a gate driver applied to a light emitting display apparatus according to an embodiment of the present disclosure, and FIG. 5 is an example diagram illustrating a structure of a data driver applied to a light emitting display apparatus according to an embodiment of the present disclosure.

A light emitting display apparatus according to an embodiment of the present disclosure can be used as various kinds of electronic devices. Electronic devices can be, for example, televisions, monitors, etc.

A light emitting display apparatus according to an embodiment of the present disclosure, as illustrated in FIG. 1, can include a light emitting display panel 100 which includes a display area DA displaying an image and a non-display area NDA provided outside the display area DA, a gate driver 200 which supplies gate signals GS to a plurality of gate lines GL1 to GLg provided in the display area DA of the light emitting display panel 100, a data driver 300 which supplies data voltages Vdata to a plurality of data lines DL1 to DLd provided in the display area DA of the light emitting display panel 100, a control driver 400 which controls driving of the gate driver 200 and the data driver 300, and a power supply unit 500 which supplies power to the control driver 400, the gate driver 200, the data driver 300, and the light emitting display panel 100.

First, the light emitting display panel 100 can include a display area DA and a non-display area NDA. Gate lines GL1 to GLg, data lines DL1 to DLd, and pixels P can be provided in the display area DA. Accordingly, an image can be displayed in the display area DA. Here, g and d are natural numbers. The non-display area NDA can surround the outer periphery of the display area DA.

The pixel P included in the light emitting display panel 100, as illustrated in FIG. 2, can include a light emitting device ED and a pixel driving circuit PDC which drives the light emitting device.

The pixel driving circuit can include a first circuit part 1CU including a driving transistor Tdr and connected to a data line DL and a first driving voltage line 1DVL to which a first driving voltage Va is supplied, a second circuit part 2CU connected to the light emitting device ED and to a second driving voltage line 2DVL to which a second driving voltage Vb is supplied, and an emission transistor T6 connected between the first circuit part 1CU and the second circuit part 2CU.

The first circuit part 1CU can include the driving transistor Tdr having a first terminal connected to a first voltage supply line PLA, a first transistor T1 having a first terminal connected to a data line DL, a first capacitor C1 connected between a gate of the driving transistor Tdr and a second terminal of the first transistor T1, a second transistor T2 connected between a reference voltage supply line RVL and a gate of the driving transistor Tdr, a third transistor T3 connected between a second terminal of the first transistor T1 and a second terminal of the driving transistor Tdr, a second capacitor C2 connected between the second terminal of the first transistor T1 and the second terminal of the driving transistor Tdr, and a fourth transistor T4 connected between the first driving voltage line 1DVL and the second terminal of the driving transistor Tdr. In this case, the emission transistor T6 can be connected between the second terminal of the driving transistor Tdr and the second circuit part 2CU.

The second circuit part 2CU can include a fifth transistor T5 connected between the second driving voltage line 2DVL and a first terminal of the light emitting device ED, and a third capacitor Coled connected between a first terminal and a second terminal of the light emitting device ED. However, the third capacitor Coled can be omitted. In this case, the emission transistor T6 can be connected between the first circuit part 1CU and the first terminal of the light emitting device ED.

The light emitting device ED can include a first electrode supplied with a first voltage EVDD through the driving transistor Tdr, a second electrode connected to a second voltage supply line PLB through which a second voltage is supplied, and a light emitting layer provided between the first electrode and the second electrode. The first electrode can be an anode and the second electrode can be a cathode.

The structure of the pixel P applied to a light emitting display apparatus according to an embodiment of the present disclosure is not limited to the structure illustrated in FIG. 2. Accordingly, the structure of the pixel P can be changed to various shapes.

The control driver 400 can realign input data signal IData transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control driver 400 can include a data aligner 430 which realigns input data signal IData to generate data signal Data, a control signal generator 420 which generates the gate control signal GCS and the data control signal DCS by using the timing synchronization signal TSS, an input part 410 which transmits the timing synchronization signal TSS transmitted from the external system 600 to the control signal generator 420 and transmits the input data signal IData transmitted from the external system 600 to the data aligner 430, and an output part 440 which supplies the data driver 300 with the data signals Data generated by the data aligner 430 and the data control signal DCS generated by the control signal generator 420 and supplies the gate driver 200 with the gate control signal GCS generated by the control signal generator 420.

The control signal generator 420 can generate a power control signal supplied to the power supply unit 500.

The control driver 400 can further include a storage unit for storing various information. The storage unit 450 can be included in the control driver 400 as illustrated in FIG. 3, but can be separated from the control driver 400 and provided independently.

The external system 600 can perform a function of driving the control driver 400 and an electronic device.

For example, when the electronic device is a television (TV), the external system 600 can receive various kinds of sound information and image information over a communication network and can transmit the received image information to the control driver 400. For example, the external system 600 can convert the image information into input data signals IData and transmit the input data signals IData to the control driver 400.

The power supply unit 500 can generate various powers and supply the generated powers to the control driver 400, the gate driver 200, the data driver 300, and the light emitting display panel 100.

The gate driver 200 can be directly embedded into the non-display area NDA by using a gate-in panel (GIP) type, or the gate driver 200 can be provided in the display area DA in which light emitting devices ED are provided, or the gate driver 200 can be provided on a chip on film mounted in the non-display area NDA.

The gate driver 200 can supply gate pulses GP1 to GPg to the gate lines GL1 to GLg.

When a gate pulse GP generated by the gate driver 200 is supplied to a gate of the first transistor T1 included in the pixel P, the first transistor T1 can be turned on. When the first transistor T1 is turned on, data voltage Vdata supplied through a data line DL can be supplied to the pixel P.

When a gate-off signal generated by the gate driver 200 is supplied to the first transistor T1, the first transistor T1 can be turned off. When the first transistor T1 is turned off, a data voltage cannot be supplied to the pixel P any longer.

The gate signal SC1 supplied to the gate line GL can include the gate pulse GP and the gate-off signal.

To supply gate pulses GP1 to GPg to gate lines GL1 to GLg, the gate driver 200, as illustrated in FIG. 4, can include stages ST1 to STg connected to gate lines GL1 to GLg.

Each of the stages ST1 to STg can be connected to one gate line GL, but can be connected to at least two gate lines GL.

In order to generate gate pulses GP1 to GPg, a gate start signal VST and at least one gate clock GCLK which are generated by the control signal generator 420 can be transferred to the gate driver 200. For example, the gate start signal VST and the at least one gate clock GCLK can be included in the gate control signal GCS.

One of the stages ST1 to STg can be driven by a gate start signal VST to output a gate pulse GP to a gate line GL. The gate pulse GP can be generated by a gate clock GCLK.

At least one of signals output from a stage ST where a gate pulse is output can be supplied to another stage ST to drive another stage ST. Accordingly, a gate pulse can be output in another stage ST.

For example, the stages ST can be driven sequentially to sequentially supply the gate pulses GP to the gate lines GL.

In the following description, the gate signal SC1 can be referred to as a first scan signal.

In this case, each of the stages ST can generate, in addition to the gate signal SC1, a second scan signal SC2, a third scan signal SC3, and an emission signal EM to be supplied to the pixel P illustrated in FIG. 2. For this purpose, each of the stages ST can be formed in various configurations.

Each of the second scan signal SC2, the third scan signal SC3, and the emission signal EM can include a high level capable of turning on a transistor and a low level capable of turning off a transistor.

The data driver 300 can supply data voltages Vdata to the data lines DL1 to DLd.

To this end, the data driver 300, as illustrated in FIG. 5, can include a shift register 310 which outputs a sampling signal, a latch 320 which latches data signal Data received from the control driver 400, a digital-to-analog converter 330 which converts the data signal Data, transmitted from the latch 320, into a data voltage Vdata and outputs the data voltage Vdata, and an output buffer 340 which outputs the data voltage, transmitted from the digital-to-analog converter 330, to the data line DL on the basis of a source output enable signal SOE.

The shift register 310 can output the sampling signal by using the data control signal DCS received from the control signal generator 420. For example, the data control signals DCS transmitted to the shift register 310 can include a source start pulse SSP and a source shift clock signal SSC.

The latch 320 can latch data signals Data sequentially received from the control driver 400, and then output the data signals Data to the digital-to-analog converter 330 at the same time on the basis of the sampling signal.

The digital-to-analog converter 330 can convert the data signals Data transmitted from the latch 320 into data voltages Vdata and output the data voltages Vdata.

The output buffer 340 can simultaneously output the data voltages Vdata transmitted from the digital-to-analog converter 330 to data lines DL1 to DLd of the light emitting display panel 100 on the basis of the source output enable signal SOE transmitted from the control signal generator 420.

To this end, the output buffer 340 can include a buffer 341 which stores the data voltage Vdata transmitted from the digital-to-analog converter 330 and a switch 342 which outputs the data voltage Vdata stored in the buffer 341 to the data line DL on the basis of the source output enable signal SOE.

For example, when the switches 342 are turned on based on the source output enable signal SOE simultaneously supplied to the switches 342, the data voltages Vdata stored in the buffers 341 can be supplied to the data lines DL1 to DLd through the switches 342.

The data voltages Vdata supplied to the data lines DL1 to DLd can be supplied to pixels P connected to a gate line GL supplied with a gate pulse GP.

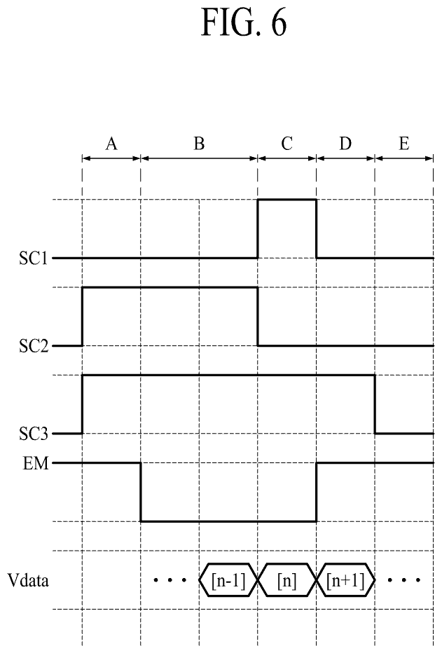

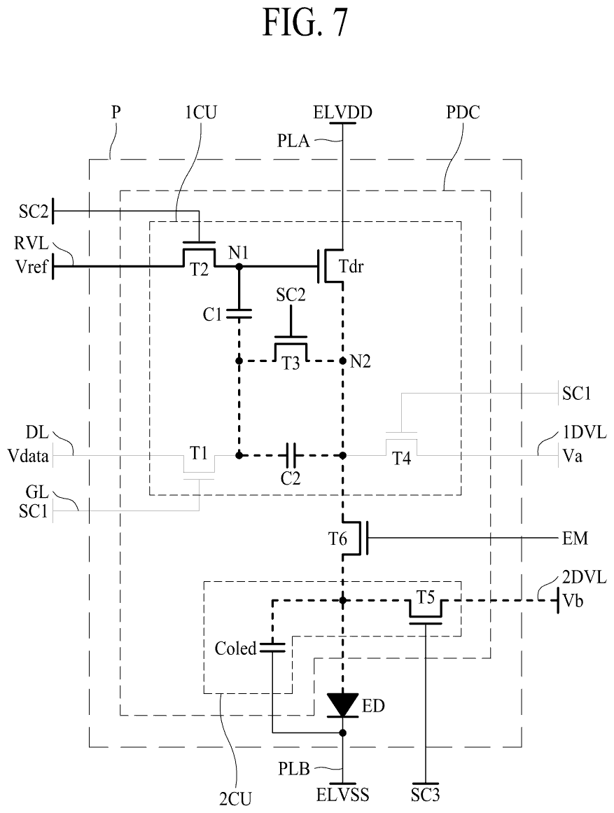

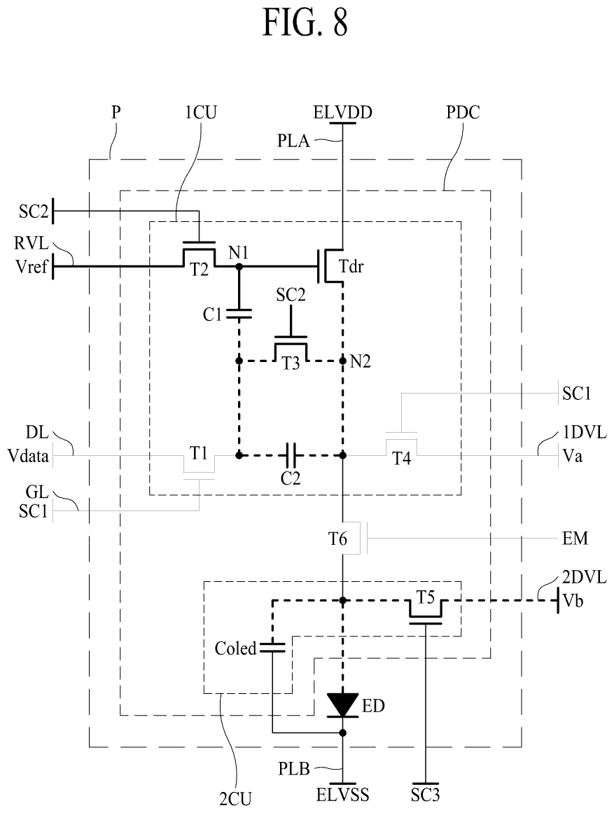

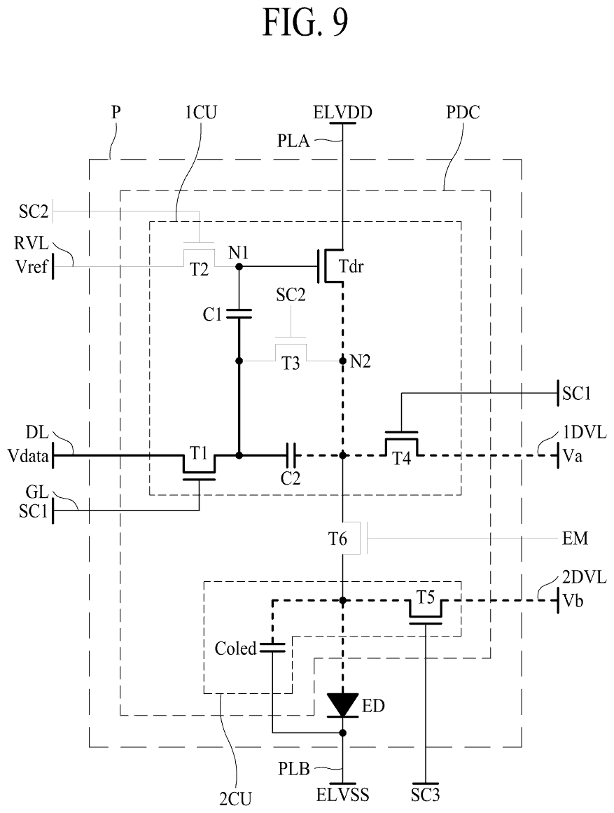

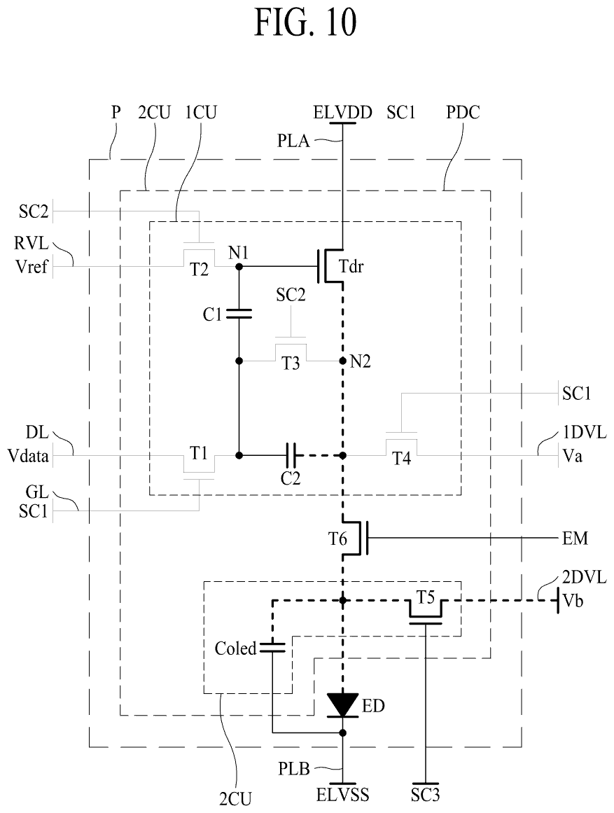

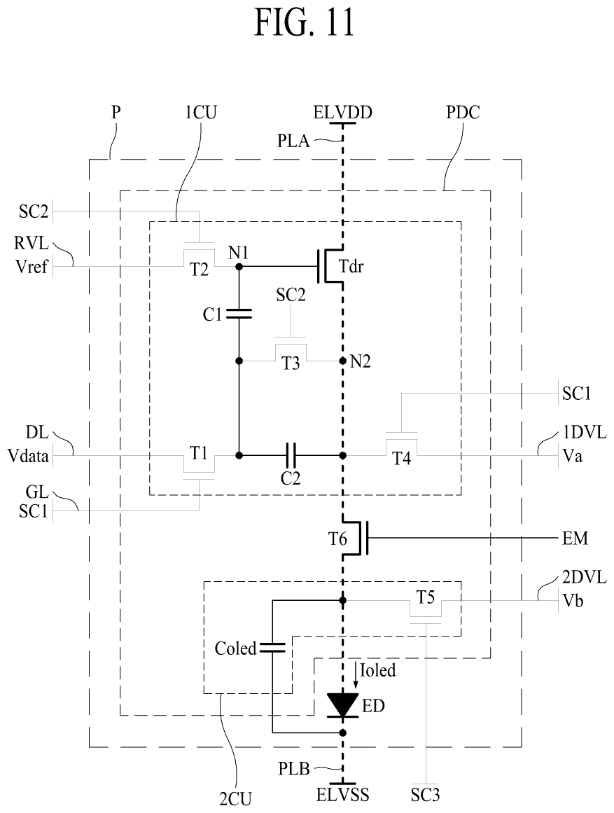

FIG. 6 is an example diagram illustrating waveforms of signals supplied to a pixel applied to a light emitting display apparatus according to an embodiment of the present disclosure, FIG. 7 is an example diagram illustrating a structure during an initialization period of a pixel applied to a light emitting display apparatus according to an embodiment of the present disclosure, FIG. 8 is an example diagram illustrating a structure during a threshold voltage sensing period of a pixel applied to a light emitting display apparatus according to an embodiment of the present disclosure, FIG. 9 is an example diagram illustrating a structure during a data writing period of a pixel applied to a light emitting display apparatus according to an embodiment of the present disclosure, FIG. 10 is an example diagram illustrating a structure during a reset period of a pixel applied to a light emitting display apparatus according to an embodiment of the present disclosure, and FIG. 11 is an example diagram illustrating a structure during a light emission period of a pixel applied to a light emitting display apparatus according to an embodiment of the present disclosure. In particular, FIG. 6 illustrates signals supplied to a pixel P connected to a n-th gate line from a n-th stage connected to the n-th gate line.

Hereinafter, with reference to FIGS. 1 to 11, a driving method of a light emitting display apparatus according to an embodiment of the present disclosure is described.

First, referring to FIGS. 6 and 7, in the initialization period (A), a low-level gate signal SC1 can be supplied to the gates of the first transistor T1 and the fourth transistor T4, a high-level second scan signal SC2 can be supplied to the gates of the second transistor T2 and the third transistor T3, a high-level third scan signal SC3 can be supplied to the gate of the fifth transistor T5, and a high-level emission signal EM can be supplied to the emission transistor T6.

Accordingly, the second transistor T2, the third transistor T3, the fifth transistor T5, and the emission transistor T6 can be turned on, and the first transistor T1 and the fourth transistor T4 can be turned off.

In this case, a reference voltage Vref can be supplied to the gate of the driving transistor Tdr through the second transistor T2, a second driving voltage Vb can be supplied to the first electrode of the light emitting device ED, and the second driving voltage Vb can be supplied to the second terminal of the driving transistor Tdr through the emission transistor T6. In the following description, the gate of the driving transistor Tdr can be denoted by reference numeral N1, and the second terminal of the driving transistor Tdr can be denoted by reference numeral N2.

Accordingly, the gate N1 of the driving transistor Tdr can be initialized by the reference voltage Vref, the second terminal N2 of the driving transistor Tdr can be initialized by the second driving voltage Vb, and the first electrode of the light emitting device ED can be initialized by the second driving voltage Vb.

That is, in the initialization period (A), the gate and the second terminal of the driving transistor Tdr and the first electrode of the light emitting device ED can be initialized.

In this case, a potential difference (=Vref−Vb) between the reference voltage Vref and the second driving voltage Vb can be stored in the first capacitor C1, and 0V can be stored in the second capacitor C2.

Next, referring to FIGS. 6 and 8, in the threshold voltage sensing period (B), a low-level gate signal SC1 can be supplied to the gates of the first transistor T1 and the fourth transistor T4, a high-level second scan signal SC2 can be supplied to the gates of the second transistor T2 and the third transistor T3, a high-level third scan signal SC3 can be supplied to the gate of the fifth transistor T5, and a low-level emission signal EM can be supplied to the emission transistor T6.

Accordingly, the second transistor T2, the third transistor T3, and the fifth transistor T5 can be turned on, and the first transistor T1, the fourth transistor T4, and the emission transistor T6 can be turned off.

In this case, the reference voltage Vref can be supplied to the gate of the driving transistor Tdr through the second transistor T2, and the second driving voltage Vb can be supplied to the first electrode of the light emitting device ED.

Accordingly, the gate N1 of the driving transistor Tdr can be initialized by the reference voltage Vref, a potential difference (=Vref−Vth) between the reference voltage Vref and the threshold voltage (Vth) of the driving transistor Tdr can be supplied to the second terminal N2 of the driving transistor Tdr, and the first electrode of the light emitting device ED can be initialized by the second driving voltage Vb.

In this case, the threshold voltage (Vth) of the driving transistor Tdr can be stored in the first capacitor C1, and 0V can be stored in the second capacitor C2.

That is, in the threshold voltage sensing period (B), the threshold voltage (Vth) of the driving transistor Tdr can be stored in the first circuit part 1CU, particularly in the first capacitor C1. In detail, during the threshold voltage sensing period (B), the threshold voltage of the driving transistor Tdr can be sensed and stored in the first circuit part 1CU.

In this case, the first electrode of the light emitting device ED can be continuously initialized by the second driving voltage Vb from the initialization period (A) to the threshold voltage sensing period (B).

Next, referring to FIGS. 6 and 9, in the data writing period (C), a high-level gate signal SC1 can be supplied to the gates of the first transistor T1 and the fourth transistor T4, a low-level second scan signal SC2 can be supplied to the gates of the second transistor T2 and the third transistor T3, a high-level third scan signal SC3 can be supplied to the gate of the fifth transistor T5, and a low-level emission signal EM can be supplied to the emission transistor T6.

Accordingly, the first transistor T1, the fourth transistor T4, and the fifth transistor T5 can be turned on, and the second transistor T2, the third transistor T3, and the emission transistor T6 can be turned off.

In this case, a data voltage Vdata can be supplied to the first capacitor C1 and the second capacitor C2 through a data line DL and the first transistor T1, a first driving voltage Va can be supplied to the second terminal of the driving transistor Tdr through the fourth transistor T4, and the second driving voltage Vb can be supplied to the first electrode of the light emitting device ED.

Accordingly, a voltage equal to the sum of the data voltage Vdata and the threshold voltage (Vth) can be supplied to the gate N1 of the driving transistor Tdr, a voltage equal to the first driving voltage Va can be supplied to the second terminal N2 of the driving transistor Tdr, and the first electrode of the light emitting device ED can be initialized by the second driving voltage Vb.

In this case, the threshold voltage of the driving transistor Tdr can be stored in the first capacitor C1, and a potential difference (=Vdata−Va) between the data voltage Vdata and the first driving voltage Va can be stored in the second capacitor C2.

That is, during the data writing period (C), the data voltage Vdata can be stored in the first circuit part 1CU, in particular, in the second capacitor C2. In particular, during the data writing period (C), the data voltage Vdata can be stored in the first circuit part 1CU in a form of a potential difference (=Vdata−Va) between the data voltage Vdata and the first driving voltage Va.

In this case, as described above, the first capacitor (C1) can still store the threshold voltage (Vth) of the driving transistor Tdr, which is stored during the threshold voltage sensing period (B).

Therefore, in the data writing period (C), both the data voltage Vdata and the threshold voltage (Vth) can be stored in the first circuit part 1CU.

In addition, the first electrode of the light emitting device ED can be continuously initialized by the second driving voltage Vb from the initialization period (A) to the data writing period (C).

Next, referring to FIGS. 6 and 10, during the reset period (D), a low-level gate signal SC1 can be supplied to the gates of the first transistor T1 and the fourth transistor T4, a low-level second scan signal SC2 can be supplied to the gates of the second transistor T2 and the third transistor T3, a high-level third scan signal SC3 can be supplied to the gate of the fifth transistor T5, and a high-level emission signal EM can be supplied to the emission transistor T6.

Accordingly, the fifth transistor T5 and the emission transistor T6 can be turned on, while the first transistor T1, second transistor T2, third transistor T3, and fourth transistor T4 can be turned off.

In this case, the second driving voltage Vb can be supplied to the second terminal N2 of the driving transistor Tdr through the emission transistor T6, and the second driving voltage Vb can be supplied to the first electrode of the light emitting device ED.

Accordingly, a voltage obtained by subtracting the first driving voltage Va from the sum of the threshold voltage (Vth), the data voltage Vdata, and the second driving voltage Vb is supplied to the gate N1 of the driving transistor Tdr, the second terminal N2 of the driving transistor Tdr can be initialized by the second driving voltage Vb supplied through the fifth transistor T5 and the sixth transistor T6, and the first electrode of the light emitting device ED can be initialized by the second driving voltage Vb.

That is, during the reset period (D), the second node N2 of the driving transistor Tdr and the first electrode of the light emitting device ED, which are electrically connected to each other through the emission transistor T6, can be initialized by the second driving voltage Vb.

In this case, the first capacitor C1 can store the threshold voltage of the driving transistor Tdr, and the second capacitor C2 can store a potential difference (=Vdata−Va) between the data voltage Vdata and the first driving voltage Va. Also, the third capacitor Coled can store a potential difference (=Vb−ELVSS) between the second driving voltage Vb and a second voltage ELVSS.

The voltage (=Vb−ELVSS) stored in the third capacitor Coled can be a pre-charging voltage, and can be lower than the voltage of the first electrode capable of turning on the light emitting device ED. Therefore, during the reset period (D), light cannot be emitted from the light emitting device ED.

Also, the first electrode of the light emitting device ED can be continuously initialized by the second driving voltage Vb from the initialization period (A) to the reset period (D).

Finally, referring to FIGS. 6 and 11, during the light emission period (E), a low-level gate signal SC1 can be supplied to the gates of the first transistor T1 and the fourth transistor T4, a low-level second scan signal SC2 can be supplied to the gates of the second transistor T2 and the third transistor T3, a low-level third scan signal SC3 can be supplied to the gate of the fifth transistor T5, and a high-level emission signal EM can be supplied to the emission transistor T6.

Accordingly, the emission transistor T6 can be turned on, the first transistor T1, second transistor T2, third transistor T3, fourth transistor T4, and fifth transistor T5 can be turned off, and the driving transistor Tdr can be turned on. Therefore, current can flow through the driving transistor Tdr, the emission transistor T6, and the light emitting device ED, and thus, light can be emitted from the light emitting device ED.

In this case, a voltage obtained by subtracting the first driving voltage Va from the sum of the threshold voltage (Vth), the data voltage Vdata, and a voltage Voled supplied to the first electrode of the light emitting device ED can be supplied to the gate N1 of the driving transistor Tdr, and the voltage Voled supplied to the first electrode of the light emitting device ED can be supplied to the second terminal N2 of the driving transistor Tdr.

Also, the threshold voltage of the driving transistor Tdr can be stored in the first capacitor C1, and the potential difference (=Vdata−Va) between the data voltage Vdata and the first driving voltage Va can be stored in the second capacitor C2.

The current Ioled flowing through the light emitting device ED during the light emission period (E) can be proportional to the square of the voltage obtained by subtracting the threshold voltage (Vth) of the driving transistor Tdr from the potential difference between the gate N1 and the source (second terminal) of the driving transistor Tdr (hereinafter referred to as a gate-source voltage (Vgs)), as shown in [Equation 1].

$$Ioled = {k ( V gs - V th )}^{2} \qquad [ Equation 1 ]$$

In [Equation 1], k can be a constant considering the mobility, channel width, and channel length of the driving transistor Tdr.

In the above example, the gate-source voltage (Vgs) of the driving transistor Tdr can be as shown in [Equation 2].

$$V gs = V th + V data - V a \qquad [ Equation 2 ]$$

In this case, the gate-source voltage (Vgs) of the driving transistor Tdr can be equal to the sum (=Vth+Vdata−Va) of the voltage stored in the first capacitor C1 (e.g., threshold voltage (Vth)) and the voltage stored in the second capacitor C2 (e.g., data voltage Vdata-first driving voltage Va).

Therefore, the voltage obtained by subtracting the threshold voltage (Vth) of the driving transistor Tdr from the gate-source voltage (Vgs) of the driving transistor Tdr can be expressed as [Equation 3].

$$V gs - V th = V data - V a \qquad [ Equation 3 ]$$

Therefore, according to [Equations 1] and [Equation 3], the current Ioled flowing through the light emitting device ED can be proportional to the square of the potential difference between the data voltage Vdata and the first driving voltage Va.

Accordingly, in the light emitting display apparatus according to an embodiment of the present disclosure, the magnitude of the current Ioled flowing through the light emitting device ED is not related to the threshold voltage (Vth) of the driving transistor Tdr and can be determined by the data voltage Vdata and the first driving voltage Va.

The luminance of light emitted from the light emitting device ED can be determined by the magnitude of the current Ioled flowing through the light emitting device ED.

Therefore, even if the driving transistor Tdr is deteriorated due to the prolonged use of the light emitting display apparatus according to an embodiment of the present disclosure, the luminance of light output from the light emitting device ED can be changed only by the data voltage Vdata and the first driving voltage Va, and is not affected by the threshold voltage Vth of the driving transistor Tdr.

Accordingly, the quality of the light emitting display apparatus according to an embodiment of the present disclosure can be maintained over a long period.

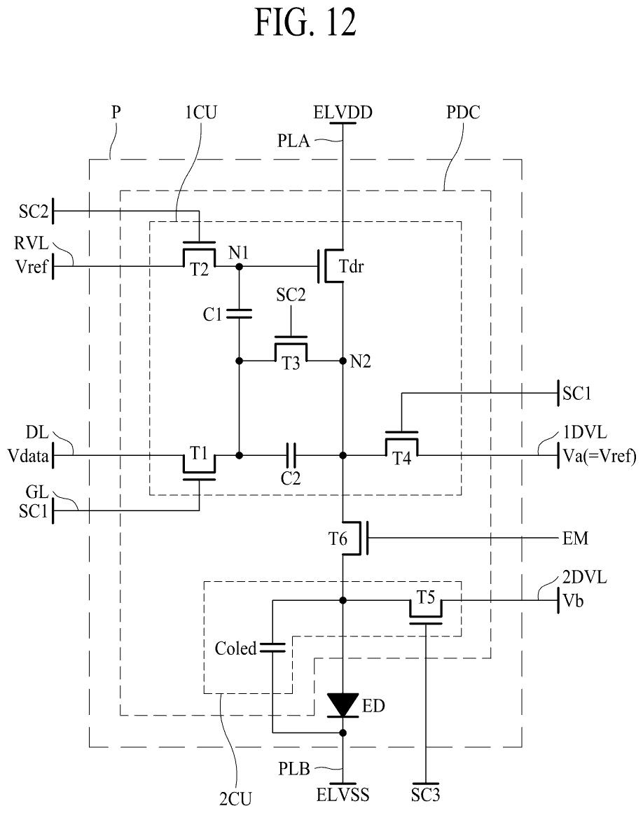

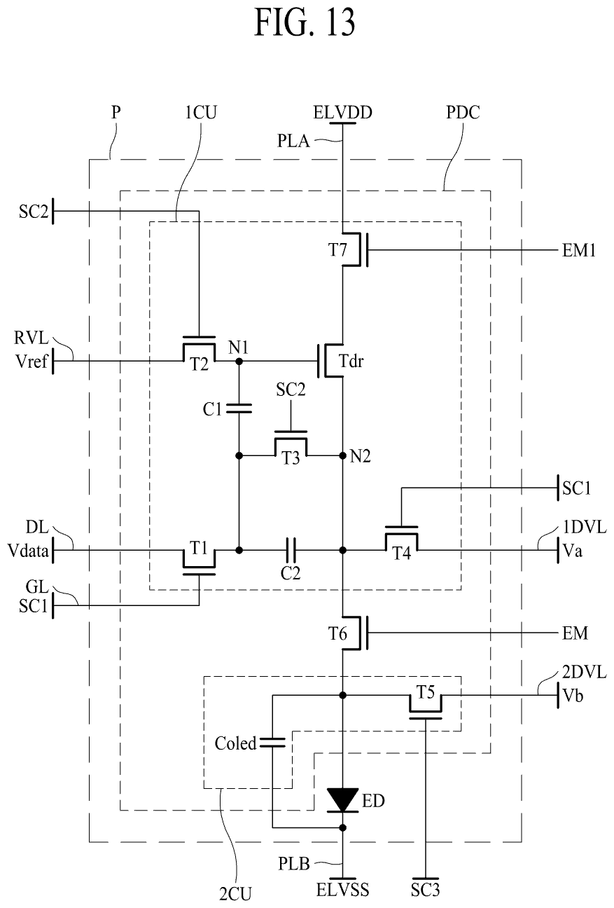

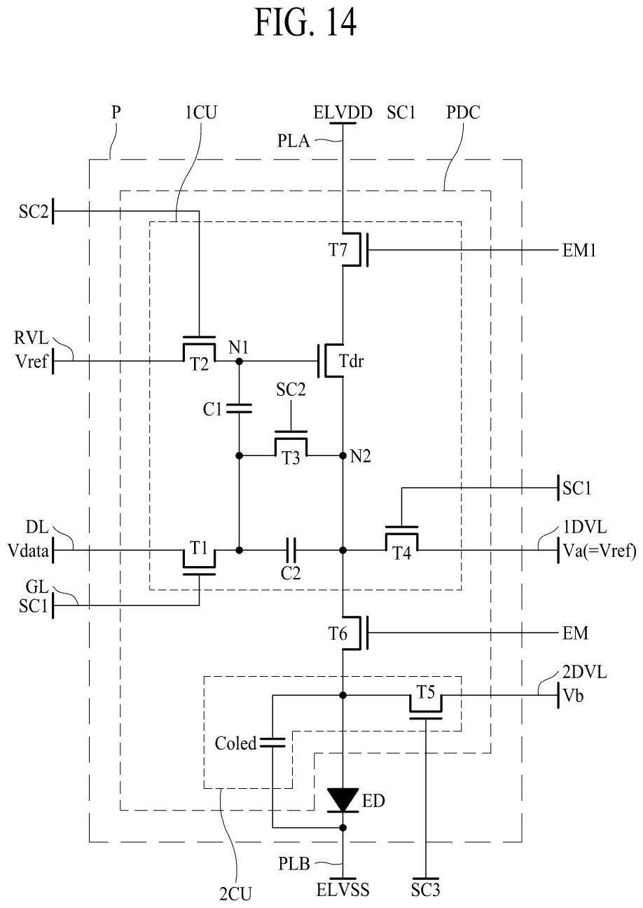

FIGS. 12 to 14 are other example diagrams illustrating a structure of a pixel applied to a light emitting display apparatus according to an embodiment of the present disclosure, and FIG. 15 is an example diagram illustrating waveforms of signals supplied to the pixel illustrated in FIGS. 13 and 14. In the following description, details that are the same as or similar to those described with reference to FIGS. 1 to 11 are omitted or briefly described.

First, the structure of a pixel driving circuit PDC illustrated in FIG. 12 is the same as that of the pixel driving circuit PDC illustrated in FIG. 2.

In this case, the reference voltage Vref can be used as the first driving voltage Va. For example, the reference voltage Vref can be supplied to the second transistor T2, and can also be supplied to the second terminal N2 of the driving transistor Tdr through the fourth transistor T4.

Therefore, when the pixel driving circuit PDC illustrated in FIG. 12 is used, the pixel P can include only a first driving voltage line 1DVL to which the first driving voltage Va is supplied, and a separate reference voltage supply line RVL may not be necessary. That is, when the first driving voltage line 1DVL is connected to the second transistor T2, the first driving voltage line 1DVL can serve as the reference voltage supply line RVL.

Therefore, the number of lines, which are connected to the pixel P in the light emitting display apparatus in which the pixel P illustrated in FIG. 12 is applied, can be reduced compared to the number of lines, which are connected to the pixel P in the light emitting display apparatus in which the pixel P illustrated in FIG. 2 is applied, and accordingly, the structure of the light emitting display panel 100 can be further simplified.

Next, in the pixel driving circuit PDC illustrated in FIG. 13, compared to the pixel driving circuit PDC illustrated in FIG. 2, an auxiliary emission transistor T7 connected between a first voltage supply line PLA to which a first voltage ELVDD is supplied and the driving transistor Tdr is further provided.

For example, a first terminal of the auxiliary emission transistor T7 can be connected to the first voltage supply line PLA, a second terminal of the auxiliary emission transistor T7 can be connected to the first terminal of the driving transistor Tdr, and an auxiliary emission signal EM1 can be supplied to a gate of the auxiliary emission transistor T7.

The auxiliary emission transistor T7 can be turned off during the initialization period (A) in which the driving transistor Tdr and the light emitting device ED are initialized by the second driving voltage Va.

For example, as illustrated in FIGS. 13 and 15, during the initialization period (A) and the data writing period (C), a low-level auxiliary emission signal EM1 can be supplied to the gate of the auxiliary emission transistor T7, and accordingly, the auxiliary emission transistor T7 can be turned off during the initialization period (A) and the data writing period (C). The auxiliary emission transistor T7 can also be turned off during the reset period (D).

Accordingly, during the initialization period (A), the data writing period (C), and the reset period (D), leakage current through the first voltage supply line PLA can be prevented.

Therefore, during the initialization period (A), the driving transistor Tdr and the light emitting device ED can be accurately initialized by the second driving voltage Vb, during the data writing period (C), the data voltage Vdata can be accurately stored, and during the reset period (D), the second terminal of the driving transistor Tdr and the first electrode of the light emitting device ED can be accurately initialized by the second driving voltage Vb.

Finally, the structure of the pixel driving circuit PDC illustrated in FIG. 14 is the same as that of the pixel driving circuit PDC illustrated in FIG. 13.

In this case, the reference voltage Vref can be used as the first driving voltage Va.

Therefore, when the pixel driving circuit PDC illustrated in FIG. 14 is used, the pixel P can include only a first driving voltage line 1DVL to which the first driving voltage Va is supplied, and there is no need for a separate reference voltage supply line RVL.

Accordingly, in a display apparatus in which the pixel P illustrated in FIG. 14 is applied, the number of lines connected to the pixel P can be reduced compared to a display apparatus in which the pixel P illustrated in FIG. 13 is applied, and thereby, the structure of the display panel 100 can be simplified.

In addition, in the pixel driving circuit PDC illustrated in FIG. 14, compared to the pixel driving circuit PDC illustrated in FIG. 2, an auxiliary emission transistor T7 connected between the first voltage supply line PLA supplying the first voltage ELVDD and the driving transistor Tdr is further provided.

Accordingly, as described with reference to FIG. 13, in a display apparatus in which the pixel P illustrated in FIG. 14 is applied, during the initialization period (A), the data writing period (C), and the reset period (D), a low-level auxiliary emission signal EM1 can be supplied to the gate of the auxiliary emission transistor T7, and accordingly, the auxiliary emission transistor T7 can be turned off during the initialization period (A), the data writing period (C), and the reset period (D).

Accordingly, during the initialization period (A), the data writing period (C), and the reset period (D), leakage current through the first voltage supply line PLA can be prevented.

Therefore, during the initialization period (A), the driving transistor Tdr and the light emitting device ED can be accurately initialized by the second driving voltage Vb, during the data writing period (C), the data voltage Vdata can be accurately stored, and during the reset period (D), the second terminal of the driving transistor Tdr and the first electrode of the light emitting device ED can be accurately initialized by the second driving voltage Vb.

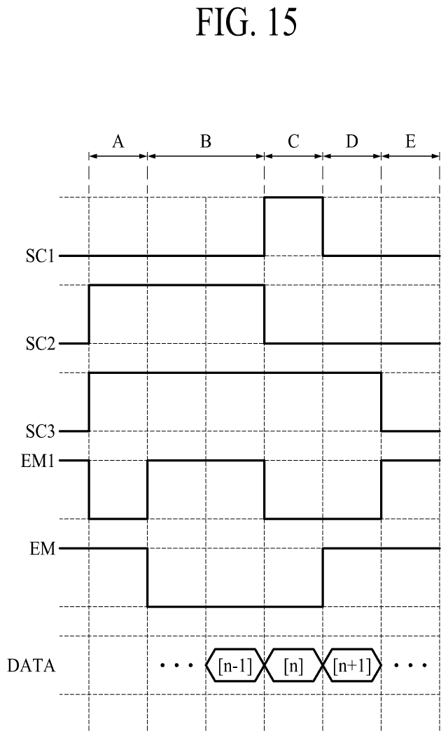

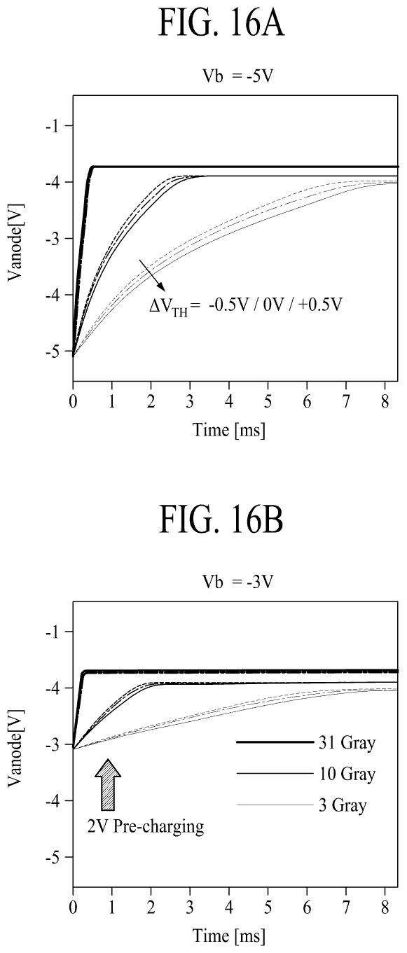

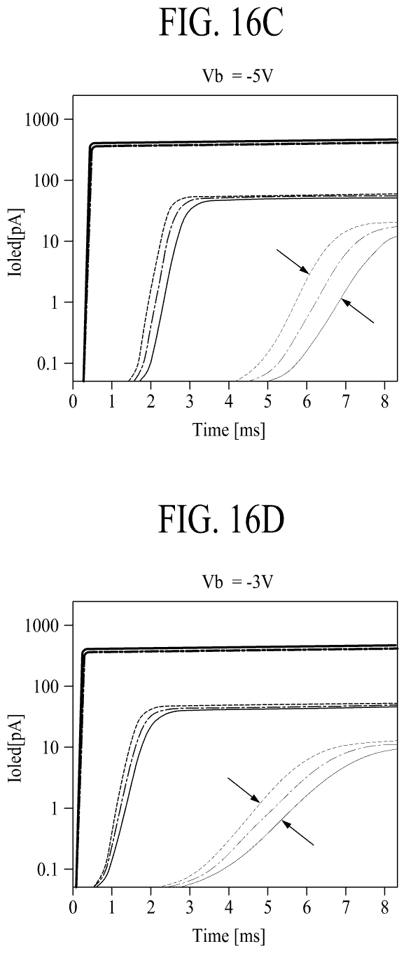

FIGS. 16A to 16D are example diagrams illustrating the effect depending on a change in the magnitude of the second driving voltage applied to a display apparatus according to an embodiment of the present disclosure.

Hereinafter, various features of a display apparatus according to an embodiment of the present disclosure will be described.

First, as described above, the current Ioled flowing through the light emitting device ED can be controlled by the data voltage Vdata and the first driving voltage Va and is not affected by the threshold voltage (Vth) of the driving transistor Tdr. In this case, the first driving voltage Va can be fixed at a constant level.

Accordingly, the luminance of the light emitting device ED is not affected by the threshold voltage (Vth) of the driving transistor Tdr and can be controlled only by the data voltage Vdata.

In this case, if the current Ioled flowing to the light emitting device ED is affected by the threshold voltage (Vth), as in the past, the data voltage Vdata has to be generated over a wide range from a negative value to a positive value considering the magnitude and variation of the threshold voltage (Vth). To this end, the data driver has to be designed to generate data voltages ranging from negative to positive values. Therefore, a complex structure of the data driver may be required.

However, in the display apparatus according to an embodiment of the present disclosure, because the current Ioled flowing through the light emitting device ED is not affected by the threshold voltage (Vth), the range of the data voltage Vdata can be narrower than in the conventional case. In particular, according to an embodiment of the present disclosure, the data voltage Vdata can be one of positive values. Therefore, the data driver 300 can generate the data voltage Vdata by using only positive voltages. That is, the data voltage Vdata supplied through the data line DL can have a voltage greater than 0.

Accordingly, the structure of the data driver 300 applied to the display apparatus according to an embodiment of the present disclosure can be simpler than a conventional data driver designed to generate both negative and positive data voltages, thereby reducing the manufacturing cost of the display apparatus.

Next, during the initialization period (A), the first circuit part 1CU and the second circuit part 2CU can be electrically connected by the emission transistor T6, and the driving transistor Tdr and the light emitting device ED can be simultaneously initialized by the second driving voltage Vb.

Accordingly, initialization of the driving transistor Tdr and the light emitting device ED can be performed simply.

In particular, in the display apparatus according to an embodiment of the present disclosure, the first electrode of the light emitting device ED can be continuously initialized by the second driving voltage Vb through the initialization period (A), the threshold voltage sensing period (B), the data writing period (C), and the reset period (D). Accordingly, the possibility of abnormal light output from the light emitting device can be reduced.

Next, during the threshold voltage sensing period (B), the first circuit part 1CU and the second circuit part 2CU can be electrically separated by the emission transistor T6, and the threshold voltage (Vth) of the driving transistor Tdr can be stored in the first circuit part 1CU.

In addition, during the data writing period (C), the first circuit part 1CU and the second circuit part 2CU can be electrically separated by the emission transistor T6, and the data voltage Vdata supplied through the data line DL can be stored in the first circuit part 1CU.

That is, during the threshold voltage sensing period (B) and the data writing period (C), the first circuit part 1CU can be electrically separated from the second circuit part 2CU. Accordingly, the operation method of the threshold voltage sensing period (B) and the data writing period (C) can be variously changed.

In addition, the threshold voltage sensing period (B) and the data writing period (C) can also proceed independently. Therefore, the threshold voltage sensing period (B) can be set to various lengths regardless of the data writing period (C).

For example, as the threshold voltage sensing period (B) increases, the threshold voltage (Vth) can be sensed more accurately.

Accordingly, in the display apparatus according to an embodiment of the present disclosure, the threshold voltage sensing period (B) can be variously increased, thereby enhancing the threshold voltage sensing function and improving the quality of the display apparatus.

Next, during the light emission period (E), the first circuit part 1CU and the second circuit part 2CU can be electrically connected by the emission transistor T6, and light can be emitted from the light emitting device ED by the current Ioled supplied from the driving transistor Tdr through the emission transistor T6.

In particular, during the reset period (D) immediately before the light emission period (E), as described above, the second terminal N2 of the driving transistor Tdr and the first electrode of the light emitting device ED can be simultaneously initialized by the second driving voltage Vb.

Therefore, during the light emission period (E) occurring after the reset period (D), no voltage difference occurs between the second terminal N2 of the driving transistor Tdr and the first electrode of the light emitting device ED.

Because no voltage difference occurs between the second terminal N2 of the driving transistor Tdr and the first electrode of the light emitting device ED during the light emission period (E), the rise or fall time of the voltage at the first electrode of the light emitting device ED can be constant. Accordingly, the period or timing of outputting light from the light emitting device ED can be maintained consistently, thereby improving the quality of the display apparatus.

Finally, to initialize the light emitting device ED, the second driving voltage Vb supplied to the first electrode of the light emitting device ED can be set lower than the voltage of the first electrode (hereinafter simply referred to as anode voltage) that allows light emission from the light emitting device ED.

Accordingly, light can be quickly output from the light emitting device ED even in the low gray level. In addition, even if the luminance is changed from high to low gray level, the size or intensity of light output from the light emitting device can be quickly adjusted. Moreover, current error can be reduced.

As described above, the anode of the light emitting device ED can be the first electrode of the light emitting device ED. Also, the second driving voltage Vb can be an initialization voltage.

For example, the anode voltage capable of emitting light from the light emitting device ED should be applied to the first electrode of the light emitting device ED during the light emission period (E) for light to be output from the light emitting device ED.

In this case, if the light emitting device ED is not initialized to a specific voltage (for example, the first driving voltage), the anode voltage of the first electrode of the light emitting device ED gradually increases, and light can be output from the light emitting device ED only when a voltage higher than or equal to an anode voltage capable of outputting light is supplied to the first electrode.

In this case, due to differences in characteristics of the light emitting devices or the driving transistors Tdr, the rise time of the anode voltage can differ depending on gray levels, or the rise time of the anode voltage can differ for each light emitting device. Accordingly, light output timing can differ even for the same gray level. This can cause a difference in luminance. This difference can be more severe at low gray level.

However, in a display apparatus according to an embodiment of the present disclosure, the first electrode of the light emitting device ED can be initialized by the second driving voltage Vb, thereby shortening the voltage rise time of the first electrode. Accordingly, errors in voltage rise time can be reduced. Therefore, the quality of the display apparatus can be improved. That is, the second driving voltage Vb can be a pre-charging voltage of the first electrode.

For example, FIGS. 16A and 16B are graphs illustrating changes in the voltage of the first electrode (e.g., anode voltage) when second driving voltages Vb of −5V and −3V are applied. According to the graphs, light can be emitted from the light emitting device when the anode voltage is approximately-2V.

In this case, compared to when the second driving voltage Vb is-5V, when the second driving voltage Vb is-3V, the period during which light is emitted from the light emitting device can be shorter. This means that when the second driving voltage Vb is close to the anode voltage at which light can be emitted, the light emission period can be shorter.

In addition, when the first electrode of the light emitting device ED is initialized by the second driving voltage Vb, even when luminance changes from a high gray level to a low gray level, the intensity or magnitude of light output from the light emitting device can be quickly adjusted.

For example, if the first electrode of the light emitting device ED is not initialized, when changing from a high gray level to a low gray level, the voltage of the first electrode should decrease. This can increase the time until light at the low gray level is output.

However, in a display apparatus according to an embodiment of the present disclosure, after light at a high gray level is output, because the first electrode of the light emitting device ED can be initialized by the second driving voltage Vb, light at a low gray level can be quickly output even after the high gray level.

In other words, by adjusting the second driving voltage Vb, differences in light emission delay time can be reduced.

Also, FIGS. 16C and 16D are graphs illustrating current errors when a second driving voltages Vb of −5V and −3V are applied.

For example, according to FIGS. 16C and 16D, when a second driving voltage Vb of −3V is applied, the current error can be smaller.

The features of the light emitting display apparatus according to an embodiment of the present disclosure are briefly summarized as follows.

A light emitting display apparatus according to an embodiment of the present disclosure comprises a light emitting device configured to emit light; and a pixel driving circuit configured to drive the light emitting device, wherein the pixel driving circuit comprises: a first circuit part including a driving transistor and connected to a data line and a first driving voltage line to which a first driving voltage is supplied; a second circuit part connected to the light emitting device and to a second driving voltage line to which a second driving voltage is supplied; and an emission transistor connected between the first circuit part and the second circuit part.

A current flowing through the light emitting device is controlled by the data voltage and the first driving voltage.

During an initialization period, the first circuit part and the second circuit part are electrically connected by the emission transistor, and the driving transistor and the light emitting device are initialized by the second driving voltage.

During a threshold voltage sensing period, the first circuit part and the second circuit part are electrically separated by the emission transistor, and a threshold voltage of the driving transistor is stored in the first circuit part.

During a data writing period, the first circuit part and the second circuit part are electrically separated by the emission transistor, and a data voltage supplied through the data line is stored in the first circuit part.

During the data writing period, the light emitting device is initialized by the second circuit part.

During a reset period, the first circuit part and the second circuit part are electrically connected by the emission transistor, and the driving transistor and the light emitting device are initialized by the second circuit part.

During the reset period, the driving transistor and the light emitting device are initialized by the second driving voltage.

During a light emission period, the first circuit part and the second circuit part are electrically connected by the emission transistor, and light is emitted from the light emitting device by a current supplied from the driving transistor through the emission transistor.

The pixel driving circuit further comprises an auxiliary emission transistor connected between a first voltage supply line supplied with a first voltage and the driving transistor.

The auxiliary emission transistor is turned off during an initialization period in which the driving transistor and the light emitting device are initialized by the second driving voltage.

The second driving voltage is lower than an anode voltage that causes the light emitting device to emit light.

The data voltage supplied through the data line is greater than 0.

The light emitting device is initialized by the second circuit part during an initialization period in which the driving transistor is initialized, during a threshold voltage sensing period in which a threshold voltage of the driving transistor is sensed, during a data writing period in which a data voltage is supplied through the data line, and during a reset period between the data writing period and a light emission period in which light is emitted.

The first circuit part comprises: a driving transistor including a first terminal connected to a first voltage supply line; a first transistor including a first terminal connected to the data line; a first capacitor connected between a gate of the driving transistor and a second terminal of the first transistor; a second transistor connected between a reference voltage supply line and the gate of the driving transistor; a third transistor connected between the second terminal of the first transistor and a second terminal of the driving transistor; a second capacitor connected between the second terminal of the first transistor and the second terminal of the driving transistor; and a fourth transistor connected between a first driving voltage line and the second terminal of the driving transistor, wherein the emission transistor is connected between the second terminal of the driving transistor and the second circuit part.

The second circuit part comprises: a fifth transistor connected between the second driving voltage line and a first terminal of the light emitting device; and a third capacitor connected between the first terminal of the light emitting device and a second terminal of the light emitting device, wherein the emission transistor is connected between the first circuit part and the first terminal of the light emitting device.

The light emitting display apparatus according to the present disclosure can be applied to all electronic devices in which it is necessary to display an image. For example, the light emitting display apparatus according to the present disclosure can be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display devices, televisions, wall paper display devices, signage devices, game devices, laptops, monitors, cameras, camcorders, and home appliances.

According to the light emitting display apparatus of an embodiment of the present disclosure, light corresponding to the data voltage can be emitted from the light emitting device regardless of the threshold voltage of the driving transistor. Therefore, the quality of the light emitting display apparatus can be improved.

According to the light emitting display apparatus of an embodiment of the present disclosure, the light emitting display apparatus can be driven using only data voltages having positive values. Accordingly, there is no need to manufacture a data driver for outputting data voltages of various levels, and thus, there is no need to consider a new structure for the data driver.

According to the light emitting display apparatus of an embodiment of the present disclosure, because the light emitting device can be continuously initialized, the possibility of abnormal light output from the light emitting device can be reduced.

According to the light emitting display apparatus of an embodiment of the present disclosure, the first electrode of the light emitting device can be initialized with a voltage smaller than the voltage required for the light emitting device to emit light. Therefore, even at low gray levels, light can be quickly emitted from the light emitting device, and even if the luminance is changed from high to low gray level, light can be rapidly output from the light emitting device, and thus, current errors between gray levels can be reduced.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A light emitting display apparatus, comprising:
a light emitting device configured to emit light; and
a pixel driving circuit configured to drive the light emitting device,
wherein the pixel driving circuit comprises:
a first circuit part including a driving transistor, the first circuit part connected to a data line and connected to a first driving voltage line to which a first driving voltage is for being supplied;
a second circuit part connected to the light emitting device and connected to a second driving voltage line to which a second driving voltage is for being supplied; and
an emission transistor connected between the first circuit part and the second circuit part.

2. The light emitting display apparatus of claim 1, wherein a current flowing through the light emitting device is controlled by a data voltage and the first driving voltage.

3. The light emitting display apparatus of claim 1, wherein, during an initialization period, the first circuit part and the second circuit part are electrically connected by the emission transistor, and the driving transistor and the light emitting device are initialized by the second driving voltage.

4. The light emitting display apparatus of claim 1, wherein, during a threshold voltage sensing period, the first circuit part and the second circuit part are electrically separated by the emission transistor, and a threshold voltage of the driving transistor is stored in the first circuit part.

5. The light emitting display apparatus of claim 1, wherein, during a data writing period, the first circuit part and the second circuit part are electrically separated by the emission transistor, and a data voltage supplied through the data line is stored in the first circuit part.

6. The light emitting display apparatus of claim 5, wherein, during the data writing period, the light emitting device is initialized by the second circuit part.

7. The light emitting display apparatus of claim 1, wherein, during a reset period, the first circuit part and the second circuit part are electrically connected by the emission transistor, and the driving transistor and the light emitting device are initialized by the second circuit part.

8. The light emitting display apparatus of claim 7, wherein, during the reset period, the driving transistor and the light emitting device are initialized by the second driving voltage.

9. The light emitting display apparatus of claim 1, wherein, during a light emission period, the first circuit part and the second circuit part are electrically connected by the emission transistor, and light is emitted from the light emitting device by a current supplied from the driving transistor through the emission transistor.

10. The light emitting display apparatus of claim 1, wherein the pixel driving circuit further comprises an auxiliary emission transistor connected between a first voltage supply line supplied with a first voltage and the driving transistor.

11. The light emitting display apparatus of claim 10, wherein the auxiliary emission transistor is turned off during an initialization period in which the driving transistor and the light emitting device are initialized by the second driving voltage.

12. The light emitting display apparatus of claim 1, wherein the second driving voltage is lower than an anode voltage that causes the light emitting device to emit light.

13. The light emitting display apparatus of claim 5, wherein the data voltage supplied through the data line is greater than 0.

14. The light emitting display apparatus of claim 1, wherein the light emitting device is initialized by the second circuit part during an initialization period in which the driving transistor is initialized, during a threshold voltage sensing period in which a threshold voltage of the driving transistor is sensed, during a data writing period in which a data voltage is supplied through the data line, and during a reset period between the data writing period and a light emission period in which light is emitted.

15. The light emitting display apparatus of claim 1, wherein the first circuit part comprises:
the driving transistor including a first terminal connected to a first voltage supply line;
a first transistor including a first terminal connected to the data line;
a first capacitor connected between a gate of the driving transistor and a second terminal of the first transistor;
a second transistor connected between a reference voltage supply line and the gate of the driving transistor;
a third transistor connected between the second terminal of the first transistor and a second terminal of the driving transistor;
a second capacitor connected between the second terminal of the first transistor and the second terminal of the driving transistor; and
a fourth transistor connected between the first driving voltage line and the second terminal of the driving transistor,
wherein the emission transistor is connected between the second terminal of the driving transistor and the second circuit part.

16. The light emitting display apparatus of claim 1, wherein the second circuit part comprises:
a fifth transistor connected between the second driving voltage line and a first terminal of the light emitting device; and
a third capacitor connected between the first terminal of the light emitting device and a second terminal of the light emitting device,
wherein the emission transistor is connected between the first circuit part and the first terminal of the light emitting device.
